(19) United States
(12) Patent Application Publication
(10) Pub. No.: US 2025/0376269 A1
(43) Pub. Date: Dec. 11, 2025

(54) AIRCRAFT TAXI ASSIST SYSTEM

(71) Applicant: HONEYWELL INTERNATIONAL INC., Charlotte, NC (US)

(72) Inventors: Karthikeyan M, Madurai (IN); Ari Narayanan, Madurai (IN); Gobinathan Baladhandapani, Madurai (IN)

(73) Assignee: HONEYWELL INTERNATIONAL INC., Charlotte, NC (US)

(21) Appl. No.: 18/777,040

(22) Filed: Jul. 18, 2024

(30) Foreign Application Priority Data
Jun. 5, 2024 (IN) 202411043559

(51) Int. Cl. B64D 47/04; F21S 41/657; F21W 107/30

(52) U.S. Cl. CPC B64D 47/04; F21S 41/657; F21W 2107/30

(57) ABSTRACT

A taxi assist system for an aircraft includes a first light source, a second light source, an assigned taxiway data source, an aircraft data source, and a processing system. The first light source is movable and is configured to emit a first light beam ahead of the aircraft. The second light source is movable and is configured to emit a second light beam ahead of the aircraft. The assigned taxiway data source supplies assigned taxiway data indicative of an assigned taxiway. The aircraft data source supplies at least aircraft position data indicative of a position of the aircraft. The processing system energizes the first and second light sources to emit the first and second light beams and supplies position commands that cause the first and second light beams to project to a turning position that corresponds to a position at which the aircraft should begin turning onto the assigned taxiway.

### CROSS REFERENCE TO RELATED APPLICATION

The present application claims benefit of prior filed India Provisional Patent Application No. 20/241,1043559, filed Jun. 5, 2024, which is hereby incorporated by reference herein in its entirety.

### TECHNICAL FIELD

The present disclosure relates to aircraft and, more specifically, to a system that provides assistance to pilots while taxiing an aircraft at an airport.

### BACKGROUND

Taxiing an aircraft to and from a runway can be a taxing task for a pilot. This is especially true, even for experienced pilots, when operating in an unfamiliar airport. Identifying an assigned taxiway in busy airports requires enhanced pilot skills and attention and thus can increase pilot workload. To reduce the runway occupancy time, it is desirable for pilots to locate the assigned taxiway relatively quickly and vacate the runway as soon as possible. As may be appreciated, steering the aircraft into an unassigned taxiway can have undesired effects.

Various taxi assistance systems and applications have been developed to alleviate the above-noted concerns. Some examples of these systems and applications include the Surface Indications and Alert System (SURF-IA), Taxi Wiz, Go Direct, and various airport moving map (AMM) applications. However, these systems and applications, while safe and robust, do exhibit certain drawbacks. For example, these systems and applications require undesirable head-down time, whereas pilots typically prefer looking outside the cockpit during ground maneuvering operations.

Hence, there is a need for a that system provides assistance to pilots while taxiing an aircraft at an airport that does not rely on undesirable head-down time and that also allows pilots to look outside the cockpit during ground maneuvers. The present disclosure addresses at least this need.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one embodiment, a taxi assist system for an aircraft on a ground surface includes a first light source, a second light source, an assigned taxiway data source, an aircraft data source, and a processing system. The first light source is movably mounted on a first wing of the aircraft and is configured, upon being energized, to emit a first light beam ahead of the aircraft. The first light source is moveable, relative to the first wing, in response to first light source position commands. The second light source is movably mounted on a second wing of the aircraft and is configured, upon being energized, to emit a second light beam ahead of the aircraft. The second light source is moveable, relative to the second wing, in response to second light source position commands. The assigned taxiway data source is configured to supply assigned taxiway data that is indicative of an assigned taxiway onto which the aircraft is to traverse. The aircraft data source is configured to supply at least aircraft position data that is indicative of a position of the aircraft. The processing system is in operable communication with the first light source, the second light source, the taxiway data source, and the aircraft position data source. The processing system is coupled to receive the assigned taxiway data and the aircraft position data and is configured, upon receipt thereof, to (i) energize the first and second light sources to emit the first and second light beams, respectively, and (ii) supply the first and second light source position commands to the first and second light sources, respectively, that cause the first and second light beams to project to a turning position on the ground surface, the turning position corresponding to a position at which the aircraft should begin turning onto the assigned taxiway.

In another embodiment, a taxi assist system for an aircraft on a ground surface includes a first light source, a second light source, an assigned taxiway data source, an aircraft data source, and a processing system. The first light source is movably mounted on a first wing of the aircraft and is configured, upon being energized, to emit a first light beam ahead of the aircraft. The first light source is moveable, relative to the first wing, in response to first light source position commands. The second light source is movably mounted on a second wing of the aircraft and is configured, upon being energized, to emit a second light beam ahead of the aircraft. The second light source is moveable, relative to the second wing, in response to second light source position commands. The assigned taxiway data source is configured to supply assigned taxiway data that is indicative of an assigned taxiway onto which the aircraft is to traverse. The aircraft data source is configured to supply at least aircraft position data that is indicative of a position of the aircraft. The processing system is in operable communication with the first light source, the second light source, the taxiway data source, and the aircraft position data source. The processing system is coupled to receive the assigned taxiway data and the aircraft position data and is configured, upon receipt thereof, to: (i) energize the first and second light sources to emit the first and second light beams, respectively, (ii) supply the first and second light source position commands to the first and second light sources, respectively, that cause the first and second light beams to project to a turning position on the ground surface, the turning position corresponding to a position at which the aircraft should begin turning onto the assigned taxiway, (iii) determine when the aircraft is at or within a predetermined distance of the turning position, and (iv) when the aircraft is at or within the predetermined distance, supply the first and second light source position commands to the first and second movable light sources, respectively, that cause the first and second light beams to project to positions on the ground surface that correspond to a turn direction for the aircraft to maneuver onto the assigned taxiway.

In yet another embodiment, an aircraft includes a fuselage, a first wing coupled to and extending from the fuselage, a second wing coupled to and extending from the fuselage, and a taxi assist system disposed in the aircraft and configured to assist the aircraft taxiing on a ground surface. The taxi assist system includes a first light source, a second light source, an assigned taxiway data source, an aircraft data source, and a processing system. The first light source is movably mounted on the first wing and is configured, upon being energized, to emit a first light beam ahead of the aircraft. The first light source is moveable, relative to the first wing, in response to first light source position commands. The second light source is movably mounted on the second wing and is configured, upon being energized, to emit a second light beam ahead of the aircraft. The second light source is moveable, relative to the second wing, in response to second light source position commands. The assigned taxiway data source is configured to supply assigned taxiway data that is indicative of an assigned taxiway onto which the aircraft is to traverse. The aircraft data source is configured to supply at least aircraft position data that is indicative of a position of the aircraft. The processing system is in operable communication with the first light source, the second light source, the taxiway data source, and the aircraft position data source. The processing system is coupled to receive the assigned taxiway data and the aircraft position data and is configured, upon receipt thereof, to (i) energize the first and second light sources to emit the first and second light beams, respectively, and (ii) supply the first and second light source position commands to the first and second light sources, respectively, that cause the first and second light beams to project to a turning position on the ground surface, the turning position corresponding to a position at which the aircraft should begin turning onto the assigned taxiway.

Furthermore, other desirable features and characteristics of the taxi assist system will become apparent from the subsequent detailed description and the appended claims, taken in conjunction with the accompanying drawings and the preceding background.

### BRIEF DESCRIPTION OF DRAWINGS

The present disclosure will hereinafter be described in conjunction with the following drawing figures, wherein like numerals denote like elements, and wherein:

FIG. 1 depicts a plan view of one embodiment of an aircraft;

FIG. 2 depicts a functional block diagram of one embodiment of a taxi assist system that may be implemented in the aircraft of FIG. 1;

FIG. 3 depicts a top view of an aircraft on a runway showing an example of how the taxi assist system of FIG. 2 may cause light beams to project to a turning position on the runway;

FIG. 4 depicts a top view of an aircraft on a taxiway showing an example of how the taxi assist system of FIG. 2 may cause light beams to project to a turning position on the taxiway;

FIG. 5 depicts a top view of an aircraft on a runway showing an example of how the taxi assist system of FIG. 2 may cause light beams to guide the aircraft to turn onto an assigned taxiway;

FIG. 6 depicts a top view of an aircraft on a taxiway showing an example of how the taxi assist system of FIG. 2 may cause light beams to project when the aircraft begins turning onto an unassigned taxiway; and

FIG. 7 depicts a top view of an aircraft on a taxiway showing an example of how the taxi assist system of FIG. 2 may cause light beams to project when the aircraft turns onto an unassigned taxiway.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

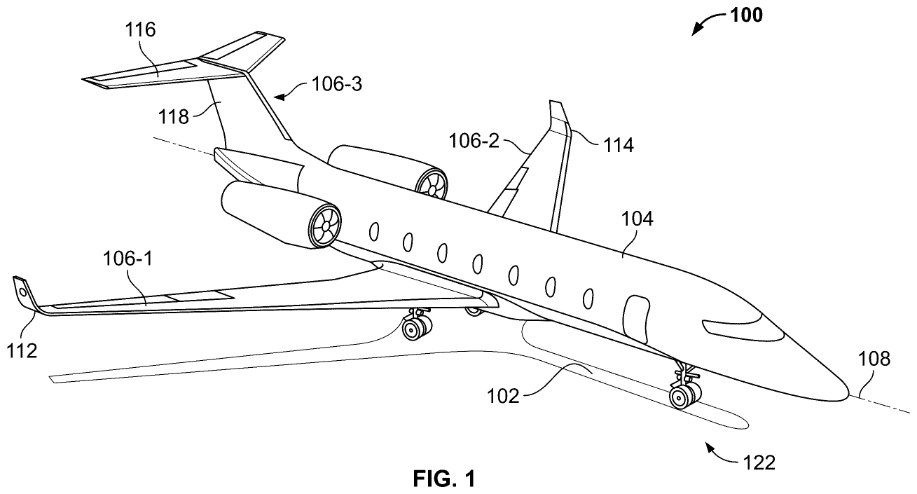

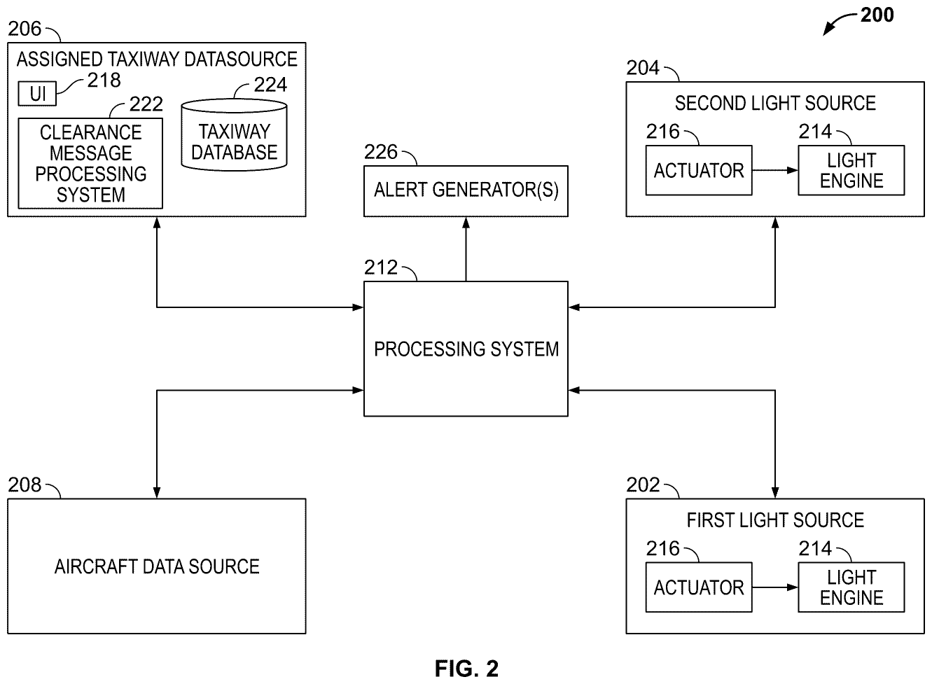

Referring first to FIG. 1, an example embodiment of an aircraft 100 is depicted. The example aircraft 100 is located on a ground surface 102 and includes a fuselage 104 and a plurality of aircraft surfaces 106. The fuselage 104 is symmetrically formed about a roll axis 108 and the aircraft surfaces 106 are each coupled to and extend from the fuselage 102. In the depicted embodiment, the plurality of aircraft surfaces 106 includes at least a first wing 106-1, which extends from the fuselage 102 to a first wingtip 112, a second wing 106-2, which extends from the fuselage 102 to a second wingtip 114, and an empennage 106-3, which includes a horizontal stabilizer 116 and a vertical stabilizer 118. It will be appreciated that other aircraft may include other aircraft surfaces. Though not depicted in FIG. 1, the aircraft 100 is equipped with a taxi assist system. A functional block diagram of one such embodiment of a taxi assist system is depicted in FIG. 2 and with reference thereto will now be described.

The depicted taxi assist system 200 includes a first light source 202, a second light source 204, an assigned taxiway data source 206, an aircraft data source 208, and a processing system 212. The first light source 202 is movably mounted on the first wing 106-1 and the second light source 204 is movably mounted on the second wing 106-2. Although the first and second light sources 202, 204 could be movably mounted at various locations on the first and second wings 106-1, 106-2, each is preferably mounted on the first wingtip 112 and the second wingtip 114, respectively.

Regardless of the specific mounting positions, the first light source 202 is configured, upon being energized, to emit a first light beam ahead of the aircraft 100 and is moveable, relative to the first wing 106-1, in response to first light source position commands. Similarly, the second light source 204 is configured, upon being energized, to emit a second light beam ahead of the aircraft 100, and is source moveable, relative to the second wing 106-2, in response to second light source position commands. To implement this functionality, and as FIG. 2 further depicts, the first and second light sources 202, 204, at least in the depicted embodiment, each include a light engine 214 and an actuator 216. The light engines 214 may be implemented using any one of numerous types of light engines. For example, each may be implemented using one or more laser lights, one or more light emitting diodes (LEDs), or one or more incandescent lights, just to name a few non-limiting examples. In one particular embodiment, the light engines 214 are implemented using a laser source. It will additionally be appreciated that the light engines 214 may emit light of various colors. In one particular embodiment, however, the light engine 214 associated with the first light source 202, and which is thus mounted on the first wing 106-1, preferably emits green light, and the light engine 214 associated with the second light source 204, and which is thus mounted on the second wing 106-2, preferably emits red light.

Each actuator 216 is coupled to its associated light engine 214 and is configured, upon receiving either the first or second light source position commands, to move its associated light engine 214. The light source position commands are indicative of a commanded position, and thus the actuators 216 move the associated light engines 214 to the commanded position. It will be appreciated that the actuators 216 may be implemented using any one of numerous types of electromechanical, hydraulic, or pneumatic actuators. Preferably, however, each is implemented using an electromechanical type of actuator.

The assigned taxiway data source 206 is configured to supply assigned taxiway data. The assigned taxiway data is indicative of an assigned taxiway onto which the aircraft 100 is to traverse. The assigned taxiway data source 206 may be disposed within the aircraft 100 or remote from the aircraft 100. Preferably, however, it is disposed within the aircraft 100. Moreover, although the assigned taxiway day source 206 is depicted as a separate data source, it will be appreciated that it may, at least in some embodiments, be part of a separate system or subsystem.

In one embodiment, the assigned taxiway data source 206 includes a user interface 218 that is configured to receive user input and, in response to the user input, to generate and supply the assigned taxiway data. In another embodiment, the assigned taxiway data source 206 includes a clearance message processing system 222 that is configured to receive air traffic control clearance messages and, in response to the ATC clearance messages, to at least generate and supply the assigned taxiway data. In both embodiments, and as FIG. 2 further depicts, the assigned taxiway data source 206 further includes a taxiway database 224 that stores taxiway data associated with various airports. The taxiway database 224 may be a separate database or may be part of a larger database.

The aircraft data source 208 is configured to supply at least aircraft position data. The aircraft position data it supplies is indicative of the position of the aircraft 100. In some embodiments, as will be described further below, the aircraft data source 208 is further configured to supply aircraft heading data, which is indicative of the heading of the aircraft 100 on the ground surface 102. The aircraft data source 208 may be implemented as part of the aircraft avionics system (non-illustrated) and may include, for example, an inertial navigation system and/or an attitude and heading reference system (AHRS), just to name a few.

The processing system 212 is in operable communication with the first light source 202, the second light source 204, the taxiway data source 206, and the aircraft position data source 208. Before proceeding further, it is noted that the processing system 212 may include or otherwise be implemented or realized using any suitable processing system and/or device, such as, for example, one or more processors, central processing units (CPUs), controllers, microprocessors, microcontrollers, processing cores and/or other hardware computing resources configured to support the operation described herein. In various implementations, the processing system 212 includes or accesses a data storage element (or memory) capable of storing programming instructions for execution that, when read and executed by the processing system 212, cause the processing system 212 to control the operations of the taxi assist system 100.

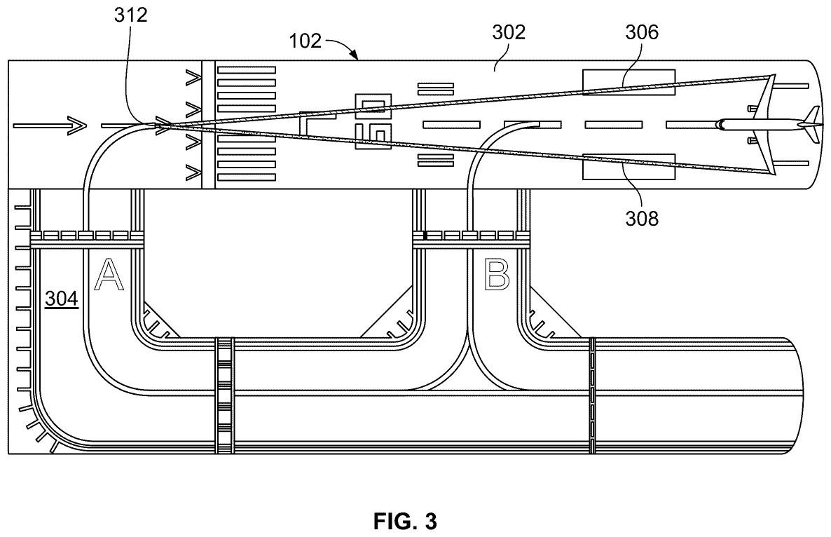

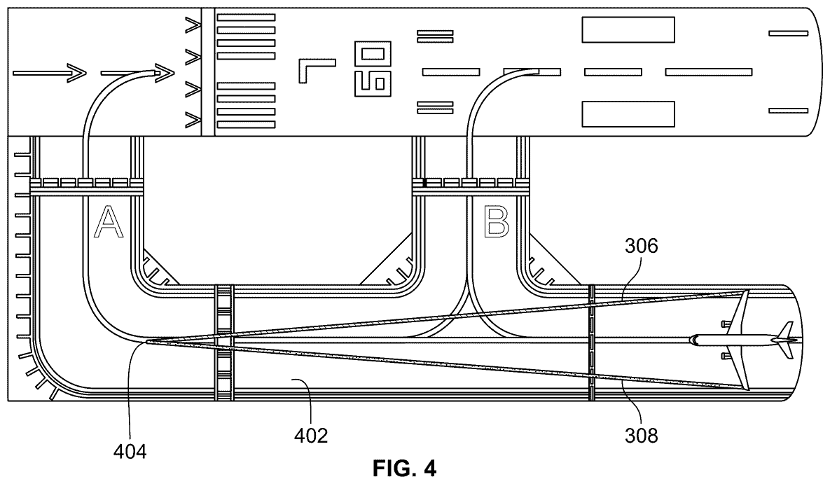

With the above in mind, the processing system 212 is coupled to receive the assigned taxiway data and the aircraft position data and is configured, upon receipt of these data, to energize the first and second light sources 202, 204 to emit the first and second light beams, respectively, and supply the first and second light source position commands to the first and second light sources 202, 204, respectively, that cause the first and second light beams to project to a turning position on the ground surface 102 that corresponds to a position at which the aircraft 100 should begin turning onto the assigned taxiway. This functionality is depicted in FIGS. 3 and 4 and with reference thereto will be described in more detail.

As depicted in FIG. 3, the aircraft 100, in the depicted scenario, is on the ground surface 102, and more specifically on the runway 302 on which the aircraft 100 landed. The aircraft 100 has been assigned to turn onto taxiway A 304 and thus the taxiway data source 206 supplies assigned taxiway data indicative of this taxiway 304 to the processing system 212. The processing system 212 processes the assigned taxiway data and the position data supplied from the aircraft position data source 208 and, in turn, energizes the first and second light sources 202, 204 to emit the first and second light beams 306, 308, respectively. The processing system 212 also supplies the first and second light source position commands to the first and second light sources 202, 204, respectively, that cause the first and second light beams 306, 308 to project to a turning position 312 on the ground surface 102. As noted above, the turning position 312 corresponds to the position at which the aircraft 100 should begin turning onto the assigned taxiway 304—in this case, taxiway A.

As depicted in FIG. 4, the aircraft 100 is also on the ground surface 102 but, in the depicted scenario, is on a taxiway 402 and is traversing to the runway 302. The aircraft 100 has been assigned to enter onto the runway via taxiway A 304. Thus, the taxiway data source 206 supplies assigned taxiway data indicative of this taxiway 304 to the processing system 212. The processing system 212 processes the assigned taxiway data and the position data supplied from the aircraft position data source 208 and, in turn, energizes the first and second light sources 202, 204 to emit the first and second light beams 306, 308, respectively. The processing system 212 also supplies the first and second light source position commands to the first and second light sources 202, 204, respectively, that cause the first and second light beams 306, 308 to project to a turning position 404 on the ground surface 102. Again, the turning position 404 corresponds to the position at which the aircraft 100 should begin turning onto the assigned taxiway 304—in this case, taxiway A.

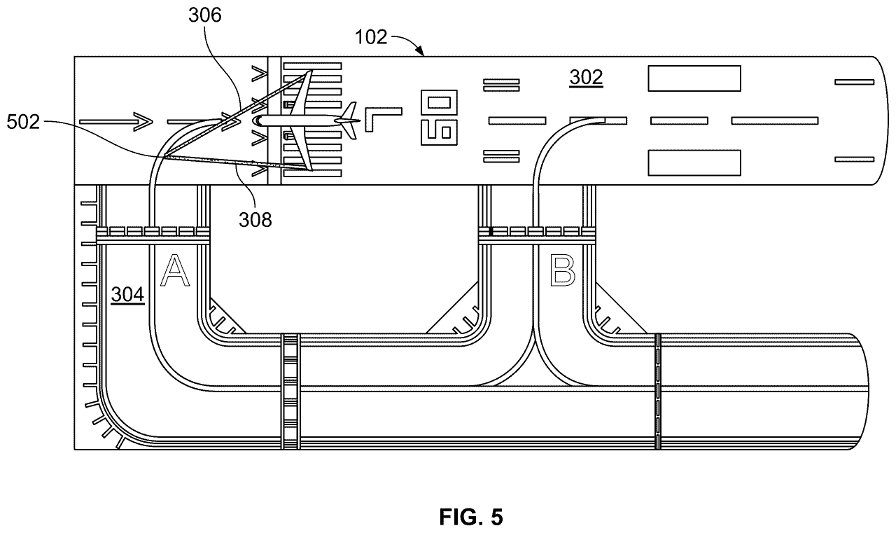

The taxi assist system 100 is also preferably configured to dynamically guide the aircraft 100 toward the assigned taxiway 304. More specifically, the processing system 212 is further configured to determine when the aircraft 100 is at or within a predetermined distance of the turning position 312, 404. Then, when the aircraft 100 is at or within the predetermined distance, the processing system supplies the first and second light source position commands to the first and second light sources 202, 204, respectively, that cause the first and second light beams 306, 308 to project to positions on the ground surface 102 that correspond to a turn direction for the aircraft 100 to maneuver onto the assigned taxiway 304. This functionality is depicted in FIG. 5, which shows the first and second light beams 306, 308 being projected to a position 502 on the ground surface 102 that lets the pilot know that, upon reaching the turning position 312, 404, the aircraft 100 should be turned leftward toward the assigned taxiway 304.

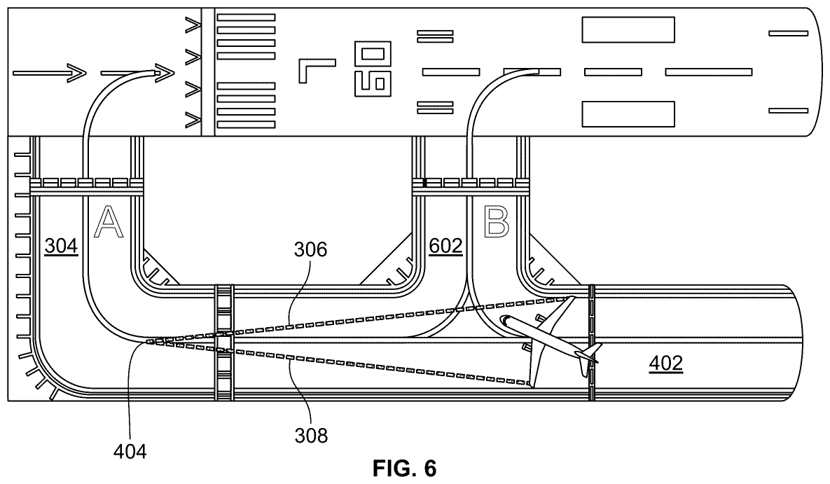

As was noted above, the aircraft data source 208 is further configured to supply aircraft heading data that is indicative of the heading of the aircraft 100 on the ground surface 102. In some embodiments, the processing system 212 is additionally coupled to receive the aircraft heading data from the aircraft data source 208, and is further configured, upon receipt of the aircraft heading data, to determine when the heading of the aircraft 100 is deviating, by a predetermined amount, from the turning position 312, 404. When the processing system 212 does determine that the heading of the aircraft 100 is deviating by the predetermined amount, it is further configured to energize the first and second light sources 202, 204 such that one or both of the first and second light beams 306, 308 are emitted with one or more variable characteristics. One example scenario that illustrates this functionality is depicted in FIG. 6 and will now be described.

In FIG. 6, the aircraft 100, like the scenario depicted in FIG. 4, is on taxiway 402, is traversing to the runway 302, and has been assigned to enter onto the runway 302 via taxiway A 304. Thus, the processing system 212 energizes the first and second light sources 202, 204 to emit the first and second light beams 306, 308, respectively to project to the turning position 404. However, in the scenario depicted in FIG. 6, the pilot has mistakenly begun to turn onto taxiway B 602, thus the heading of the aircraft 100 begins deviating from the turning position 404. When, as FIG. 6 depicts, the heading of the aircraft 100 is deviating by the predetermined amount, the processing system 212 energizes the first and second light sources 202, 204 such that the first and second light beams 306, 308 are emitted with one or more variable characteristics. In the depicted embodiment, the variable characteristic is a varying pulse pattern. It will be appreciated that in other embodiments, the variable characteristics may instead be, or also include, variations in intensity and/or color.

In addition to or instead of energizing the first and second light sources 202, 204 such that the first and second light beams 306, 308 are emitted with one or more variable characteristics, the processing system 212 may also be configured, at least in some embodiments, to generate one or more alert signals when the heading of the aircraft 100 is deviating by the predetermined amount. In such embodiments, and as FIG. 2 depicts, the system 200 may additionally include one or more alert generators 226. The one or more alert generators 226 may include one or more of visual, audible, and/or haptic alert generators.

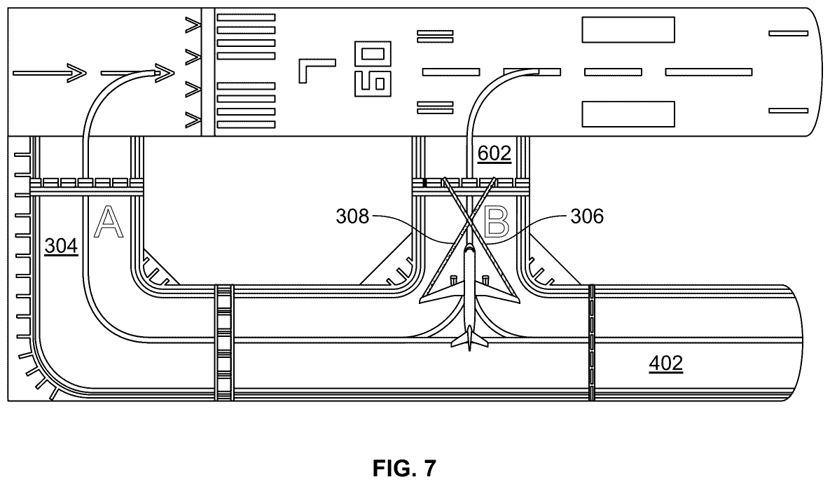

No matter the specific type (or types) of alert generator(s) 226, the processing system 212 may additionally be configured to determine when the aircraft 100 has turned onto a taxiway that differs from the assigned taxiway. The processing system 212 is further configured, upon making this determination, to supply the first and second light source position commands to the first and second movable light sources 202, 204, respectively, that cause the first and second light beams 306, 308 to intersect and produce an X-shaped pattern on the ground surface 102 ahead of the aircraft 100. This scenario is depicted in FIG. 7, where the assigned taxiway is taxiway A 304, but the pilot has turned the aircraft 100 onto taxiway B 602.

The system disclosed herein provides assistance to pilots while taxiing an aircraft at an airport that does not rely on undesirable head-down time and that also allows pilots to look outside the cockpit during ground maneuvers.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A taxi assist system for an aircraft on a ground surface, the aircraft including a fuselage, a first wing coupled to and extending from the fuselage, and a second wing coupled to and extending from the fuselage, the taxi assist system comprising:
a first light source movably mounted on the first wing and configured, upon being energized, to emit a first light beam ahead of the aircraft, the first light source moveable, relative to the first wing, in response to first light source position commands;
a second light source movably mounted on the second wing and configured, upon being energized, to emit a second light beam ahead of the aircraft, the second light source moveable, relative to the second wing, in response to second light source position commands;
an assigned taxiway data source configured to supply assigned taxiway data, the assigned taxiway data indicative of an assigned taxiway onto which the aircraft is to traverse;
an aircraft data source configured to supply at least aircraft position data, the aircraft position data indicative of a position of the aircraft; and
a processing system in operable communication with the first light source, the second light source, the taxiway data source, and the aircraft position data source, the processing system coupled to receive the assigned taxiway data and the aircraft position data and configured, upon receipt thereof, to (i) energize the first and second light sources to emit the first and second light beams, respectively, and (ii) supply the first and second light source position commands to the first and second light sources, respectively, that cause the first and second light beams to project to a turning position on the ground surface, the turning position corresponding to a position at which the aircraft should begin turning onto the assigned taxiway.

2. The system of claim 1, wherein the processing system is further configured to:
determine when the aircraft is at or within a predetermined distance of the turning position; and
when the aircraft is at or within the predetermined distance, supply the first and second light source position commands to the first and second movable light sources, respectively, that cause the first and second light beams to project to positions on the ground surface that correspond to a turn direction for the aircraft to maneuver onto the assigned taxiway.

3. The system of claim 2, wherein:
the aircraft data source is further configured to supply aircraft heading data, the aircraft heading data indicative of a heading of the aircraft on the ground surface;
the processing system is further coupled to receive the aircraft heading data and is further configured, upon receipt of the aircraft heading data, to:
determine when the heading of the aircraft is deviating, by a predetermined amount, from the position at which the aircraft should begin turning onto the assigned taxiway, and
when the heading of the aircraft is deviating by the predetermined amount, energize the first and second light sources such that one or both of the first and second light beams are emitted with one or more variable characteristics.

4. The system of claim 3, wherein the one or more variable characteristics include at least one or more of pulse pattern, intensity, and color.

5. The system of claim 3, wherein the processing system is further configured to determine when the aircraft has turned onto a runway that differs from the assigned taxiway and, in response to this determination, supply the first and second light source position commands to the first and second movable light sources, respectively, that cause the first and second light beams to intersect and produce an X-shaped pattern on the ground surface ahead of the aircraft.

6. The system of claim 3, wherein the processing system is further configured to generate one or more alert signals at least when the heading of the aircraft is deviating by the predetermined amount.

7. The system of claim 1, wherein the assigned taxiway data source comprises a user interface that is configured to receive user input and, in response to the user input, generate and supply the assigned taxiway data.

8. The system of claim 1, wherein the assigned taxiway data source comprises a clearance message processing system that is configured to receive air traffic control clearance messages and, in response to the ATC clearance messages, to at least generate and supply the assigned taxiway data.

9. The system of claim 1, wherein the first and second light sources each comprise:
a light engine; and
an actuator coupled to the light engine and is configured to selectively move the light engine.

10. The system of claim 1, wherein:
the first light source is configured to emit the first light beam having a first color; and
the first light source is configured to emit the second light beam having a second color that differs from the first color.

11. A taxi assist system for an aircraft on a ground surface, the aircraft including a fuselage, a first wing coupled to and extending from the fuselage, and a second wing coupled to and extending from the fuselage, the taxi assist system comprising:
a first light source movably mounted on the first wing and configured, upon being energized, to emit a first light beam having a first color ahead of the aircraft, the first light source moveable, relative to the first wing, in response to first light source position commands;
a second light source movably mounted on the second wing and configured, upon being energized, to emit a second light beam having a second color that differs from the first color ahead of the aircraft, the second light source moveable, relative to the second wing, in response to second light source position commands;
an assigned taxiway data source configured to supply assigned taxiway data, the assigned taxiway data indicative of an assigned taxiway onto which the aircraft is to traverse;
an aircraft data source configured to supply at least aircraft position data, the aircraft position data indicative of a position of the aircraft; and
a processing system in operable communication with the first light source, the second light source, the taxiway data source, and the aircraft position data source, the processing system coupled to receive the assigned taxiway data and the aircraft position data and configured, upon receipt thereof, to:
(i) energize the first and second light sources to emit the first and second light beams, respectively,
(ii) supply the first and second light source position commands to the first and second light sources, respectively, that cause the first and second light beams to project to a turning position on the ground surface, the turning position corresponding to a position at which the aircraft should begin turning onto the assigned taxiway,
(iii) determine when the aircraft is at or within a predetermined distance of the turning position, and
(iv) when the aircraft is at or within the predetermined distance, supply the first and second light source position commands to the first and second movable light sources, respectively, that cause the first and second light beams to project to positions on the ground surface that correspond to a turn direction for the aircraft to maneuver onto the assigned taxiway.

12. The system of claim 11, wherein:
the aircraft data source is further configured to supply aircraft heading data, the aircraft heading data indicative of a heading of the aircraft on the ground surface;
the processing system is further coupled to receive the aircraft heading data and is further configured, upon receipt of the aircraft heading data, to:
determine when the heading of the aircraft is deviating, by a predetermined amount, from the position at which the aircraft should begin turning onto the assigned taxiway, and
when the heading of the aircraft is deviating by the predetermined amount, energize the first and second light sources such that one or both of the first and second light beams are emitted with one or more variable characteristics.

13. The system of claim 12, wherein the one or more variable characteristics include at least one or more of pulse pattern, intensity, and color. 14 The system of claim 12, wherein the processing system is further configured to determine when the aircraft has turned onto a runway that differs from the assigned taxiway and, in response to this determination, supply the first and second light source position commands to the first and second movable light sources, respectively, that cause the first and second light beams to intersect and produce an X-shaped pattern on the ground surface ahead of the aircraft.

15. The system of claim 12, wherein the processing system is further configured to generate one or more alert signals at least when the heading of the aircraft is deviating by the predetermined amount.

16. The system of claim 11, wherein the assigned taxiway data source comprises a user interface that is configured to receive user input and, in response to the user input, generate and supply the assigned taxiway data.

17. The system of claim 11, wherein the assigned taxiway data source comprises a clearance message processing system that is configured to receive air traffic control clearance messages and, in response to the ATC clearance messages, to at least generate and supply the assigned taxiway data.

18. The system of claim 11, wherein the first and second light sources each comprise:
a light engine; and
an actuator coupled to the light engine and is configured to selectively move the light engine.

19. An aircraft, comprising:
a fuselage;
a first wing coupled to and extending from the fuselage;
a second wing coupled to and extending from the fuselage; and
a taxi assist system disposed in the aircraft and configured to assist the aircraft taxiing on a ground surface, the taxi assist system comprising:
a first light source movably mounted on the first wing and configured, upon being energized, to emit a first light beam ahead of the aircraft, the first light source moveable, relative to the first wing, in response to first light source position commands;
a second light source movably mounted on the second wing and configured, upon being energized, to emit a second light beam ahead of the aircraft, the second light source moveable, relative to the second wing, in response to second light source position commands;
an assigned taxiway data source configured to supply assigned taxiway data, the assigned taxiway data indicative of an assigned taxiway onto which the aircraft is to traverse;
an aircraft data source configured to supply at least aircraft position data, the aircraft position data indicative of a position of the aircraft; and
a processing system in operable communication with the first light source, the second light source, the taxiway data source, and the aircraft position data source, the processing system coupled to receive the assigned taxiway data and the aircraft position data and configured, upon receipt thereof, to (i) energize the first and second light sources to emit the first and second light beams, respectively, and (ii) supply the first and second light source position commands to the first and second light sources, respectively, that cause the first and second light beams to project to a turning position on the ground surface, the turning position corresponding to a position at which the aircraft should begin turning onto the assigned taxiway.

20. The aircraft of claim 19, wherein the processing system is further configured to:
determine when the aircraft is at or within a predetermined distance of the turning position; and
when the aircraft is at or within the predetermined distance, supply the first and second light source position commands to the first and second movable light sources, respectively, that cause the first and second light beams to project to positions on the ground surface that correspond to a turn direction for the aircraft to maneuver onto the assigned taxiway.
